(19) United States
(12) Patent Application Publication
(10) Pub. No.: US 2005/0101704 A1
(43) Pub. Date: May 12, 2005

(54) Flame retardant additive for polymers compounds with improved hydro-thermal stability

(75) Inventors: Frank Eisentraeger, Huerth (DE); Werner Krause, Huerth (DE); Sebastian Hoerold, Diedorf (DE); Wolfgang Wanzke, Augsburg (DE); Peter Anna, Ungarn (HU); Gyoergy Bertalan, Ungarn (HU); Gyoergy Marosi, Ungarn (HU); Andrea Marton, Ungarn (HU); Emese Zimonyi, Ungarn (HU)

Correspondence Address: CLARIANT CORPORATION;INTELLECTUAL PROPERTY DEPARTMENT, 4000 MONROE ROAD, CHARLOTTE, NC, 28205, US

(73) Assignee: Clariant GmbH

(21) Appl. No.: 10/839,991

(22) Filed: May 6, 2004

(30) Foreign Application Priority Data
May 13, 2003 (DE) 103 21 286.8

(51) Int. Cl. C08K 5/34; C08K 5/49

(52) U.S. Cl. 524/100; 524/115

(57) ABSTRACT

The invention relates to a flame retardant polymer compound comprising from 50-95 wt % polymer matrix related to the total amount of the flame retardant polymeric compound and 5-50 wt % of flame retardant additive system related to the total amount of the flame retardant polymeric compound.

The present invention relates to flame retardant polymer compounds, consisting of a polymer matrix and a flame retardant additive system.

Alcoholic group containing derivatives of N-heteroatom containing cyclic compounds, e.g. tris-(2-hydroxyethyl)-isocyanurate are known as effective synergists in ammonium polyphosphate containing flame retardant formulations of polyolefin compounds, such as described in EP 0 258 685 A1. However, the low melting temperature and low viscosity of the synergist limits the processing conditions of the compound.

Ester derivatives of the mentioned synergists with phosphoric acid, as described in US Pat. No 4,461,862 and with aromatic polycarboxilic acid as described in EP 0 584 567 A1 eliminates the low viscosity induced problem. The high temperature processing of the compounds, containing the above mentioned synergists and ammonium polyphosphate, is limited by the reactions between the synergists and ammonium polyphosphate, resulting in bleeding. “Bleeding” describes the loss of flame retardant additives when stored in water or in accelarated ageing test in a climate chamber.

It has been found that the melamine salt of the oligomeric compound prepared from hydroxyalkyl isocyanurate, phosphorus pentoxide, partial fatty acid ester of glycerol and silicone compounds, such as alkoxy silane and/or phenyl alkyl siloxane, results in good flame retardancy when applied in ammonium polyphoshate containing polymeric compounds, without showing the bleeding out of the flame retardants.

The invention relates therefore to a flame retardant polymer compound comprising from
50-95 wt % polymer matrix related to the total amount of the flame retardant polymeric compound and
5-50 wt % of flame retardant additive system related to the total amount of the flame retardant polymeric compound.

Surprisingly, the flame retardant polymer compound according to the present invention, shows high hydro-thermal stability and a long term storage stability, i.e. the flame retardant polymer compound can be processed at elevated temperature and can be stored for a long time without bleeding of the additives.

Preferably, the flame retardant polymer compound comprises from 60-85 wt % of a polymer matrix related to the total amount of the flame retardant polymeric compound and 15-40 wt % of a flame retardant additive system related to the total amount of the flame retardant polymeric compound.

Preferably, the flame retardant additive system consists of a mixture of as component (A) ammonium polyphosphate, (NH₄PO₃)ₙ, and as component (B) a blocked polyol according to the general formula I, 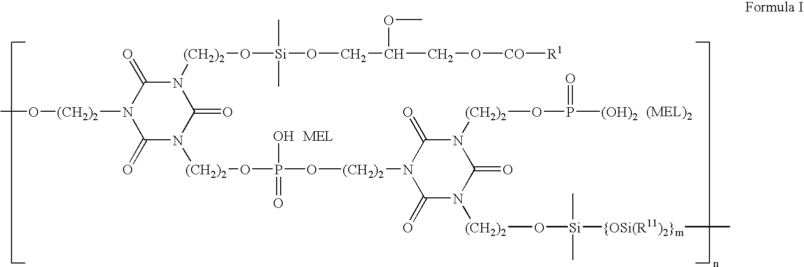
which is the melamine salt of the oligomeric reaction product of hydroxyalkyl derivate of isocyanuric acid, phosphorus pentoxide, partial fatty acid ester of glycerol and silicone compounds comprising alkoxy silane and/or hydroxy alkyl-aryl siloxane, and in which formula n has a value of 4 to 6, m has a value of 2 to 5, R¹ is an ester formed from saturated or unsaturated fatty acid and from glycerol or other polyols and having at least one free alcoholic group, R^{II} is an alkyl chain with C number 1 to 4 or a phenyl group, MEL is melamine.

More preferably, component (B) is a reaction product of tris (2-hydroxyethyl) isocyanurate, phosphorus pentoxyde, glicerol-monostearate and melamine in the presence of indifferent and reactive solvent, like alkoxy silane, as reaction medium.

Preferably, the flame retardant additive system consists of a mixture of from
90-50 wt % of component (A) and
10-50 wt % of component (B).

More preferably, the flame retardant additive system consists of a mixture of from
75-60 wt % of component (A) and
25-40 wt % of component (B).

The present invention refers also to a flame retardant polymer compound, wherein the polymer is a thermoplastic polymer like polyolefins, vinylacetate copolymers, polyamides, etc, or the blend of them.

The present invention refers also to a flame retardant polymer compound, wherein the polymer is a duroplastic polymer, like epoxy resins or unsatured polyesters.

The ammonium polyphosphate has the chemical structure (NH₄PO₃)n, wherein the n has a value between 1 and more than 10.000, preferred between 200 and 1000.

The component (B) is an additions-condensations product of the ingredients
tris(hydroxyethyl)isocyanurate (THEIC),
phosphorus pentoxide,
partial fatty acid ester of glycerol
melamine
silicone compounds, like
alkoxy silane, e.g. tetraethoxysilane, or other alkoxysilanes, and/or
hydroxy alkyl, or alkyl aryl siloxane, where the alkyl group may have 1-6 carbon atom; the aryl group is substituted or non-substituted.

The thermoplastic polymers in which the novel flame retardant combinations can be used effectively are described in the international patent application PCT/WO 97/01664.

These include:

1. Polymers of mono- or diolefins, for example polypropylene, polyisobutylene, polybutylene, poly-1-butene, polyisoprene and polybutadiene, and also polymers of cycloolefins, for example of cyclopentene or of norbornene; also polyethylene, which may have crosslinking if desired; e.g. high-density polyethylene (HDPE), high-density high-molecular-weight polyethylene (HDPE-HMW), high-density ultrahigh-molecular-weight polyethylene (HDPE-UHMW), medium-density polyethylene (MDPE), low-density polyethylene (LDPE), linear low-density polyethylene (LLDPE), or low-density branched polyethylene (VLDPE).

2. Mixtures of the above mentioned polymers, for example mixtures of polypropylene with polyisobutylene, polypropylene with polyethylene (e.g.: PP/HDPE, PP/LDPE) and mixtures of various polyethylene grades, for example LDPE/HDPE.

3. Copolymers of mono- or of diolefins with one another or with other vinyl monomers, e.g. ethylene-propylene copolymers, linear low-density polyethylene (LLDPE) and mixtures of the same with low-density polyethylene (LDPE), propylene-1-butene copolymers, propylene-isobutylene copolymers, ethylene-1-butene copolymers, etc.; and also ethylene-alkyl acrylate copolymers, ethylene-vinyl acetate copolymers and copolymers of these with carbon monoxide, and ethylene-acrylic acid copolymers and salts of these (ionomers), and also terpolymers of ethylene with propylene and with a diene, such as hexadiene, dicyclopentadiene or ethylidenenorbornene; and also mixtures of copolymers of this type with one another or with the polymers mentioned under 1., e.g. polypropylene/ethylene-propylene copolymers, LDPE/ethylene-vinyl acetate copolymers, LDPE/ethylene-acrylic acid copolymers, LLDPE/ethylene-vinyl acetate copolymers, LLDPE/ethylene-acrylic acid copolymers, and polyalkylene-carbon monoxide copolymers of alternating or random structure and mixtures of these with other polymers, e.g. with polyamides.

4. Polystyrene, poly(p-methylstyrene), poly(α-methylstyrene).

5. Copolymers of styrene or α-methylstyrene with dienes or with acrylics, e.g. styrene-butadiene, styrene-acrylonitrile, styrene-alkyl methacrylate, styrene-butadiene-alkyl acrylate, styrene-butadiene-alkyl methacrylate, styrene-maleic anhydride, styrene-acrylonitrile-methacrylate; high-impact-strength mixtures made from styrene copolymers with another polymer, e.g. with a polyacrylate, with a diene polymer or with an ethylene-propylene-diene terpolymer; and also block copolymers of styrene, e.g. styrene-butadiene-styrene, styrene-isoprene-styrene, styrene-ethylene/butylene-styrene or styrene-ethylene/propylene-styrene.

6. Graft copolymers of styrene or α-methylstyrene, e.g. styrene on polybutadiene, styrene on polybutadiene-styrene copolymers or on polybutadiene-acrylonitrile copolymers, styrene and acrylonitrile (or methacrylonitrile) on polybutadiene; styrene, acrylonitrile and methyl methacrylate on polybutadiene; styrene and maleic anhydride on polybutadiene; styrene, acrylonitrile and maleic anhydride or maleic imide on polybutadiene, styrene and maleimide on polybutadiene; styrene and alkyl acrylates and, respectively, alkyl methacrylates on polybutadiene; styrene and acrylonitrile on ethylene-propylene-diene terpolymers; styrene and acrylonitrile on polyalkyl acrylates or on polyalkyl methacrylates; styrene and acrylonitrile on acrylate-butadiene copolymers, and also mixtures of these with the polymers mentioned under 5., known as ABS polymers, MBS polymers, ASA polymers or AES polymers, for example.

7. Halogen-containing polymers, e.g. polychloroprene, chlorinated rubber, chlorinated or brominated copolymer made from isobutylene-isoprene (halogenated butyl rubber), chlorinated or chlorosulfonated polyethylene, copolymers of ethylene with chlorinated ethylene, epichlorohydrin homo- and copolymers, in particular polymers made from halogen-containing vinyl compounds, e.g. polyvinyl chloride, polyvinylidene chloride, polyvinyl fluoride, polyvinylidene fluoride; and also copolymers of these, for example vinyl chloride-vinylidene chloride, vinyl chloride-vinyl acetate and vinylidene chloride-vinyl acetate.

8. Polymers derived from α,β-unsaturated acids or from derivatives of these, for example polyacrylates and polymethacrylates, butyl-acrylate-impact-modified polymethyl methacrylates, polyacrylamides and polyacrylonitriles.

9. Copolymers of the monomers mentioned under 8. with one another or with other unsaturated monomers, e.g. acrylonitrile-butadiene copolymers, acrylonitrile-alkyl acrylate copolymers, acrylonitrile-alkoxyalkyl acrylate copolymers, acrylonitrile-vinyl halide copolymers and acrylonitrile-alkyl methacrylate-butadiene terpolymers.

10. Polymers derived from unsaturated alcohols and amines and respectively, from their acetyl derivatives or acetals, for example polyvinyl alcohol, polyvinyl acetate, polyvinyl stearate, polyvinyl benzoate, polyvinyl maleate, polyvinyl butyral, polyallylphthalate, polyallylmelamine; and also copolymers of these with the olefins mentioned under 1.

11. Polyacetals, such as polyoxymethylene, and also those polyoxymethylenes which contain comonomers, e.g. ethylene oxide; polyacetals modified with thermoplastic polyurethanes, with acrylates or with MBS.

12. Polyphenylene oxides, polyphenylene sulfides and mixtures of these oxides or sulfides with styrene polymers or with polyamides.

13. Polyamides and copolyamides derived from diamines and from dicarboxylic acids and/or from aminocarboxylic acids or from the corresponding lactams, for example nylon-4, nylon-6, nylon-6,6, 6,10, 6,9, 6,12, 4,6, 12,12, nylon-11, nylon-12, aromatic polyamides based on m-xylene, diamine and adipic acid; polyamides prepared from hexamethylenediamine and iso- and/or terephthalic acid and, if desired, from an elastomer as modifier, e.g. poly-2,4,4-trimethylhexamethylene-terephthalamide or poly-m-phenyleneisophthalamide. Block copolymers of the above mentioned polyamides with polyolefins, with olefin copolymers, with ionomers or with chemically bonded or grafted elastomers; or with polyethers, e.g. with polyethylene glycol, polypropylene glycol or polytetramethylene glycol. EPDM- or ABS-modified polyamides or copolyamides; and also polyamides condensed during processing (“IM polyamide systems”).

14. Polyureas, polyimides, polyamideimides, polyetherimides, polyesterimides, polyhydantoins and polybenzimidazoles.

15. Polyesters derived from dicarboxylic acids and from dialcohols and/or from hydroxycarboxylic acids or from the corresponding lactones, for example polyethylene terephthalate, polybutylene terephthalate, poly-1,4-dimethylolcyclohexane terephthalate, polyhydroxybenzoates, and also block polyetheresters derived from polyethers having hydroxyl end groups; polyesters modified with polycarbonates or with MBS.

16. Polycarbonates and polyester carbonates.

17. Polysulfones, polyether sulfones and polyether ketones.

18. Mixtures (polyblends) of the above mentioned polymers, e.g. PP/EPDM, polyamide/EPDM or ABS, PVC/EVA, PVC/ABS, PVC/MBS, PC/ABS, PBTP/ABS, PC/ASA, PC/PBT, PVC/CPE, PVC/acrylates, POM/thermoplastic PU, PC/thermoplastic PU, POM/acrylate, POM/MBS, PPO/HIPS, PPO/nylon-6,6 and copolymers.

Preparation of Component B:

The completion of the addition-condensation reactions is promoted by entering the components into a reactor provided with a stirrer, heating-cooling and vacuum system. The reaction is preferably carried out in the presence of an inert, high boiling solvent, e.g. petrol ether. The temperature varies from 80° C. to 140° C. The solvent and the non-consumed volatile reaction components can be eliminate in vacuum preferably.

The representative flame-retardant compounds are prepared by conventional methods, in an internal mixer at the plasticisation temperature of the polymer matrix by feeding the additives in the melted polymer. The component (B) is thermoplastic, do not require additional milling before feeding into the internal mixer, if the homogenisation process occurs at higher temperature.

The flame retarding properties of the compounds were determined by use of 10×2×100 mm-sized specimens, prepared from a pressed plates. The flammability was characterised by measuring the limited oxygen index (LOI) described in ISO 4589-2 and by the “Vertical Burning Test” UL 94. The bleeding was tested by measuring the conductivity of 100-cm³-extraction water, used for extraction of a 44×44×2 mm-sized plate.

The present invention is illustrated by the following not limiting examples

### EXAMPLE 1

The preparation of the (B1) component was performed as follows. Glycerol-monostearate of 10 g (0.028 mol) was weighted in a vessel containing 150 cm³ petroleum ether (120). It was heated up to 80° C. Holding the temperature, small portions of 50 g (0.19 mol) of tris-hydroxy-ethyl-isocyanurate (THEIC) and 43 g (0.3 mol) of phosphoros pentoxide were alternately fed into the vessel, thereafter the reaction mixture transformed into a viscous suspension. After 1 hour stirring at 80° C. the reaction mixture was neutralised with 72 g (0.57 mol) melamine. After 1 hour further stirring 250 g (1.2 mol) tetraethoxy silane and 0.1 g catalyst (dibutyl tin dilaurate solution) was added. Ethanol, evolved during the silylation reaction, was continuously distilled off at the boiling temperature of the reaction mixture. The silylation was finished when no more ethanol evolved. Solvent and the non-reacted tetraethoxy silane were removed in Rotadest using low vacuum.

The flame retardant compound was prepared in the mixing chamber of a Brabender Plastograph 2000 by homogenisation at 190° C. of 10% component B1 and 24% Exolit AP 422 and 66% PP homopolymer (MFI=4, 230° C., 2.16 kp) previously plasticised at 190° C.

### EXAMPLE 2

A second sample was prepared with the same composition as in example 1, but the homogenisation temperature was 220° C. in this case. The properties of the compounds can be seen in the Table I.

### EXAMPLE 3

The (B2) component was prepared by use of the same reaction components and proportion of components as listed in Example 1, except the following alterations: instead of 1.2 mol tetraethoxy silane 0.028 mol was used, the quantity of the petroleum ether was reduced to 7.5 cm³, necessary to agglutinate the reaction partners, the recipe contained also 3 g hydroxyl-alkyl-aryl siloxane. The preparation was performed in a temperature and stirring controllable mixing chamber of Brabender Plastograph. All the components were fed into the chamber except the tetraethoxy silane and melamine. The mixing was started with a rotor speed of 50 rpm. The temperature was elevated gradually to 80° C. and kept at this temperature for 1.5 h. After feeding the tetraethoxy silane and melamine components to the reaction mixture, the temperature was gradually elevated to 150° C., and kept at this value for 1 h. Finally the temperature was elevated to 250° C. and kept here for 10 min. The thermoplastic product was taken off from the chamber, milled after solidification, and used for preparation of the flame retardant compound.

Flame retardant compound was prepared in the mixing chamber of a Brabender Plastograph 2000 by homogenisation at 190° C. of 10% component B and 24% Exolit AP 422 and 66% PP homopolymer (MFI=4, 230° C., 2.16 kp) previously plasticised at. 190° C.

### EXAMPLE 4

A compound was prepared with the same composition as in example 3 but the homogenisation temperature was 220° C. in this case. The properties of the compounds can be seen in the Table I.

### EXAMPLE 5

A compound was prepared in the mixing chamber of a Brabender Plastograph2000 by homogenisation at 190° C. of 10% tris-hydroxy-ethyl-isocyanurate (THEIC), 24% Exolit AP 422 and 66% PP homopolymer (MFI=4, 230° C., 2.16 kp).

### EXAMPLE 6

A compound was prepared in the mixing chamber of a Brabender Plastograph2000 by homogenisation at 220° C. of 10% tris-hydroxy-ethyl-isocyanurate (THEIC), 24% Exolit AP 422 and 66% PP homopolymer (MFI=4, 230° C., 2.16 kp).

TABLE I

| | Sample | | | | | |
|---|---|---|---|---|---|---|
| | Parts by weight of components | | | | | |
| Ingredients | Example 1 | Example 2 | Example 3 | Example 4 | Example 5 | Example 6 |
| PP | 66 | 66 | 66 | 66 | 66 | 66 |
| APP | 24 | 24 | 24 | 24 | 24 | 24 |
| THEIC | | | | | 10 | 10 |
| B 1 | 10 | 10 | | | | |
| B 2 | | | 10 | 10 | | |
| temperature | 190° C. | 220° C. | 190° C. | 220° C. | 190° C. | 220° C. |
| Properties | | | | | | |
| Torque of mix. Nm | 32 | 31 | 31 | 30 | 32 | 18 |
| Conductivity of | 38 | 40 | 36 | 38 | 80 | 240 |
| extraction, water, μS | | | | | | |
| OI, % | 35 | 36 | 37 | 36 | 30 | 30 |
| UL 94 | V-0 | V-0 | V-0 | V-0 | V-0 | V-0 |

The Table I shows that the reference compounds (Example 5 and 6) have a high oxygen index and excellent UL 94 flammability, but have a high susceptibility for bleeding (characterised by measuring the conductivity of extraction water). The samples prepared in the examples 1 to 4 show low bleeding susceptibility (low conductivity of extraction water) at any processing temperature compared to the reference. These compounds have also improved flame retardancy as one can see in the higher oxygen index.

1. Flame retardant polymer compound comprising:
50-95 wt % polymer matrix related to the total amount of the flame retardant polymer compound and
5-50 wt % of flame retardant additive system related to the total amount of the flame retardant polymer compound.

2. Flame retardant polymer compound as claimed in claim 1, further comprising:
60-85 wt % of a polymer matrix related to the total amount of the flame retardant polymer compound and
15-40 wt % of a flame retardant additive system related to the total amount of the flame retardant polymer compound.

3. Flame retardant polymer compound as claimed in claim 1, wherein the flame retardant additive system consists of a mixture of as component (A) ammonium polyphosphate having the formula (NH₄PO₃)ₙ, and as component (B) a blocked polyol according to the general formula I, 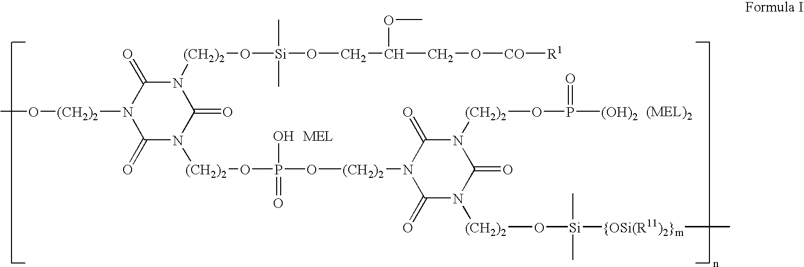
where n=4 to 6, m=2 to 5, R¹=ester formed from saturated or unsaturated fatty acid and from glycerol or other polyols and having at least one free alcoholic group,
R^{II}=alkyl chain with C number 1 to 4 or a phenyl group, MEL=melamine, wherein the melamine which is the melamine salt of the oligomeric reaction product of hydroxyalkyl derivate of isocyanuric acid, phosphorus pentoxide, partial fatty acid ester of glycerol and at least one silicone compound.

4. Flame retardant polymer compound as claimed in claim 3, wherein the flame retardant additive system consists of a mixture of from
90-50 wt % of component (A) and
10-40 wt % of component (B).

5. Flame retardant polymer compound as claimed in claim 1, wherein the flame retardant additive system consists of a mixture of from
75-60 wt % of component (A) and
25-40 wt % of component (B).

6. Flame retardant polymer compound as claimed in claim 1, wherein the polymer matrix includes at least one thermoplastic polymer.

7. Flame retardant polymer compound as claimed in claims 1, wherein the polymer matrix includes at least one duroplastic polymer.

8. The flame retardant polymer compound according to claim 3, wherein the component (B) is the reaction product of tris (2-hydroxyethyl) isocyanurate, phosphorus pentoxide, partial fatty acid ester of glycerol and melamine in an inert solvent.

9. The flame retardant polymer compound according to claim 3, wherein the component (B) is the reaction product of tris (2-hydroxyethyl) isocyanurate, phosphorus pentoxide, partial fatty acid ester of glycerol, melamine and at least one silicone compound.

10. Flame retardant polymer compound as claimed in claim 6, wherein the at least one thermoplastic polymer is selected from the group consisting of HIPS (high-impact polystyrene), polyphenylene ethers, polyamides, polyesters, polycarbonates and blends or polymer blends of the type ABS (acrylonitrile-butadiene-styrene), PC/ABS (polycarbonate/acrylonitrile-butadiene-styrene) PPE/HIPS (polyphenylene ether/high-impact polystyrene), polyamide, polyester or blends of PPE/HIPS.

11. Flame retardant polymer compound as claimed in claim 7, wherein the at least one duroplastic polymer is an epoxy resin or unsaturated polyester resin.

12. Flame retardant polymer compound as claimed in claim 3, wherein the at least one silicone compound is selected from the group consisting of alkoxysilane, hydroxy alkyl aryl siloxane, alkyl aryl siloxane and mixtures thereof.

13. Flame retardant polymer compound as claimed in claim 9, wherein the at least one silicone compound is selected from the group consisting of alkoxysilane hydroxy alkyl aryl siloxane, alkyl aryl siloxane and mixtures thereof.

14. Flame retardant polymer compound as claimed in claim 1, wherein the flame retardant additive system comprises a mixture of as component (A) ammonium polyphosphate having the formula (NH₄PO₃)ₙ, and as component (B) a blocked polyol according to the general formula I, 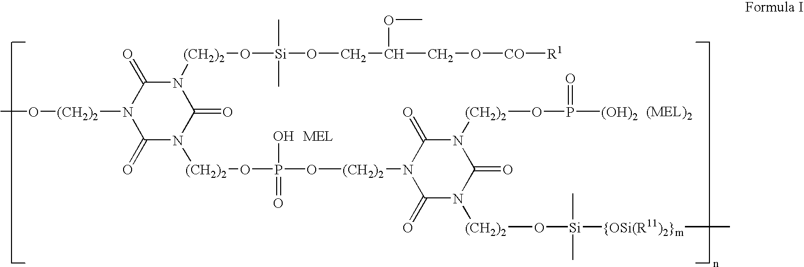
where n=4 to 6, m=2 to 5, R¹=ester formed from saturated or unsaturated fatty acid and from glycerol or other polyols and having at least one free alcoholic group, R^{II}=alkyl chain with C number 1 to 4 or a phenyl group,
MEL=melamine, wherein the melamine is the melamine salt of the oligomeric reaction product of hydroxyalkyl derivate of isocyanuric acid, phosphorus pentoxide, partial fatty acid ester of glycerol and at least one silicone compound.
